(19) United States
(12) Patent Application Publication
(10) Pub. No.: US 2024/0161446 A1
(43) Pub. Date: May 16, 2024

(54) SYSTEMS AND METHODS FOR CORPUS MANAGEMENT FOR AI TRAINING

(71) Applicant: Palantir Technologies Inc., Denver, CO (US)

(72) Inventor: Christian Sidak, West Palm Beach, FL (US)

(21) Appl. No.: 18/387,973

(22) Filed: Nov. 8, 2023

Related U.S. Application Data
(60) Provisional application No. 63/424,632, filed on Nov. 11, 2022.

(51) Int. Cl. G06V 10/40; G06F 16/29

(52) U.S. Cl. CPC G06V 10/40; G06F 16/29

(57) ABSTRACT

Systems and methods for managing data corpus are provided. For example, a method comprises: receiving an unlabeled image; identifying one or more geohashes associated with the unlabeled image; determining whether each geohash of the one or more geohashes is labeled; generating a coverage score for the unlabeled image based on the determination; evaluating whether the coverage score is below a predetermined threshold; in response to the coverage score being below the predetermined threshold, transmitting the unlabeled image to an image labeling system.

### CROSS REFERENCE TO RELATED APPLICATIONS

This application claims priority to U.S. Provisional Application No. 63/424,632, filed Nov. 11, 2022, incorporated by reference herein for all purposes.

### TECHNICAL FIELD

Certain embodiments of the present disclosure are directed to systems and methods for corpus management for artificial intelligence (AI) training. More particularly, some embodiments of the present disclosure provide systems and methods that address model bias, for example by programmatically increasing diversity of data corpus with which an AI model is trained.

### BACKGROUND

In the context of AI training, a risk in producing labeled training data is sampling bias (e.g., systematic bias, geographic bias), which can affect performance of a trained AI model. For example, if a training data source skews toward a demographic or grouping, then the performance of an AI model that was trained using a training data source could be impaired when the AI model is applied to data outside of this demographic/grouping, among other examples.

Hence it is desirable to develop improved AI training techniques.

### SUMMARY

Certain embodiments of the present disclosure are directed to systems and methods for corpus management for artificial intelligence (AI) training. More particularly, some embodiments of the present disclosure provide systems and methods that address model bias, for example by programmatically increasing diversity of data corpus with which an AI model is trained.

In some embodiments, a method for managing data corpus is provided. The method comprises: receiving an unlabeled image; identifying one or more geohashes associated with the unlabeled image; determining whether each geohash of the one or more geohashes is labeled; generating a coverage score for the unlabeled image based on the determination; evaluating whether the coverage score is below a predetermined threshold; in response to the coverage score being below the predetermined threshold, transmitting the unlabeled image to an image labeling system; wherein the method is performed using one or more processors.

In certain embodiments, a method for managing data corpus is provided. The method comprises: receiving a plurality of unlabeled images; for each unlabeled image of the plurality of unlabeled images: identifying one or more geohashes associated with the each unlabeled image of the plurality of unlabeled images; determining whether each geohash of the one or more geohashes is labeled; generating a coverage score for the each unlabeled image of the plurality of unlabeled images based on the determination; selecting one or more unlabeled images from the plurality of unlabeled images based on one or more coverage scores associated with the one or more unlabeled images; and transmitting an indication of the one or more selected unlabeled images to an image labeling system; wherein the method is performed using one or more processors.

In some embodiments, a system for managing data corpus is provided. The system includes: one or more memories comprising instructions stored thereon; and one or more processors configured to execute the instructions and perform operations comprising: receiving an unlabeled image; identifying one or more geohashes associated with the unlabeled image; determining whether each geohash of the one or more geohashes is labeled; generating a coverage score for the unlabeled image based on the determination; evaluating whether the coverage score is below a predetermined threshold; in response to the coverage score being below the predetermined threshold, transmitting the unlabeled image to an image labeling system.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 illustrates a method for corpus management according to certain embodiments of the present disclosure.

FIG. 2 illustrates another method for corpus management according to certain embodiments of the present disclosure.

FIG. 3 illustrates a further method for corpus management according to certain embodiments of the present disclosure.

FIG. 4 illustrates an example of a corpus management environment, according to certain embodiments of the present disclosure.

FIG. 5 illustrates an example image covering a plurality of geohash regions, which can be represented by a plurality of corresponding geohashes according to aspects described herein.

FIG. 6 is a simplified diagram showing a computing system for implementing aspects of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to some embodiments, machine learning analysts need millions of labeled images and/or other labeled data in order to train artificial intelligence (AI) models that can interpret images. In certain embodiments, an image refers to a still image, a live image, an image sequence, a video, and/or the like. In some embodiments, training corpus refers to labeled data (e.g., labeled images, other labeled data) for training AI models. In certain embodiments, data corpus includes raw data (e.g., unlabeled data) and/or training corpus. In certain embodiments, an AI model includes a machine learning (ML) model, a deep learning (DL) model, and/or the like. For example, if an analyst wants to train an AI model to identify fruits in an image, they will need to label a large quantity of images that contain fruit, and specify each class of label (e.g., mango, apple, orange).

It will be appreciated that the disclosed aspects may similarly be used to train a language model (LM) and/or a large language model (LLM), for example to improve the diversity of the data with which the LM and/or LLM is trained. In some examples, a language model (“LM”) may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

For instance, the LLM may be trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

In some embodiments, labeling is highly resource intensive. For example, human labelers spend lots of time labeling and reviewing millions of images. In certain embodiments, a label includes a representation of an object class (e.g., an indication of the object class). In some embodiments, a label includes an annotation (e.g., a box, a circle) added to the image and the representation of the object class (e.g., the number of objects of interest in the image). In certain embodiments, one or more images are associated with or integrated with geographic metadata. In some embodiments, the geographic metadata includes geohash (e.g., 8-character geohash, 12-charactger geohash), where each geohash represents a geographic region. In certain embodiments, one or more images each is associated with or integrated with a metadata vector, where the metadata vector includes two or more dimensions (e.g., geographic metadata, time metadata, etc.). In some embodiments, the metadata vector includes metadata associated with image-taking environment. In certain embodiments, the metadata vector includes metadata associated with image parameters (e.g., hue, saturation, etc.). In some embodiments, the metadata vector includes metadata not associated with image parameters.

According to certain embodiments, a risk (e.g., a key risk) in labeling is sampling bias (e.g., systematic bias, geographic bias), which can affect performance of trained AI models. For example, if a training data source skews towards (e.g., skews too heavily towards) some demographic or grouping, then the AI model's performance, trained using a training data source, could be impaired when the AI model is applied to data outside this grouping. For example, a model trained to recognize apples only in France might not perform properly in England, due to geographic training biases. As an example, maybe the model was only trained with red apple images, so the model may miss green apples in production. Additionally, in some examples of using computer vision (CV) models, this can include situations where the CV models begin detecting objects based on their surroundings rather than the characteristics of the objects themselves (e.g., selecting an apple because the image has a fruit bowl, but not actually picking on the characteristics of the apple itself).

According to some embodiments, a corpus management system can help to correct model bias by programmatically increasing the geographic diversity of the data corpus, based on the historical geographic coverage of the existing corpus. In certain embodiments, for a given unlabeled image, the corpus management system determines how many times that image's geographic area (e.g., geohashes) has been previously labeled based at least in part on the geographic metadata of the unlabeled image indicating what geohash the image came from. In some embodiments, a geohash being labeled refers to one or more images covering the geohash are labeled. In certain embodiments, an image being from a geohash refers to the image covering at least a part of a geographic area corresponding to the geohash. In some embodiments, an image may cover two or more geographic areas corresponding to two or more geohashes respectively.

According to some embodiments, a corpus management system can help to correct model bias by programmatically increasing data diversity of the data corpus, based on the historical geographic coverage of the existing corpus. In certain embodiments, for a given unlabeled image, the corpus management system determines how many times that image's one or more metadata categories (e.g., geographic metadata, time metadata) have been previously labeled based at least in part on the metadata vector of the unlabeled image indicating what metadata categories the image is associated. In some embodiments, a metadata vector being labeled refers to one or more images associated with the metadata vector (e.g., Mexico in the fall season) are labeled. In certain embodiments, an image being associated with a metadata vector refers to the image covering at least a part of a geographic area and/or time period corresponding to the metadata vector. In some embodiments, an image may cover two or more metadata vectors corresponding to two or more geographic areas and/or time periods respectively.

According to certain embodiments, the corpus management system can track previously labeled geohashes in the existing training corpus, and then estimates the coverage (e.g., historical coverage) for an unlabeled image, such that the system can determine if the unlabeled image is from (e.g., partially from) an unseen geohash or a previously labeled geohash. In some embodiments, the corpus management system can prioritize the labeling of unseen geographies for increased (e.g., maximal) data diversity, for example, which would prevent the labelers from relabeling different pictures of the same geographic areas many times over and causing sampling bias.

According to certain embodiments, the corpus management component (e.g., a corpus management system, a corpus management solution, etc.) can update (e.g., automatically update) the geohash coverage level every time a new image is labeled, and thus refreshes the information on which unlabeled images come from previously unknown geohashes. For example, the system has labeled geohashes in Mexico, then all new images from Mexico would get a geohash coverage score of 100%. As an example, if the system labeled no images in the United States, then an image split across the United States and Mexico border would get a coverage score of 50%, indicating that half the image came from one or more geohashes that had never before been labeled.

According to some embodiments, the corpus management component (e.g., a corpus management system, a corpus management engine, a corpus management solution, software module, software and hardware combination, etc.) can use coverage scores (e.g., coverage ratio) of unlabeled images to prioritize labeling. In certain embodiments, an unlabeled image is associated with one or more geohashes and the unlabeled image's coverage score is associated with whether the one or more geohashes are labeled. In certain embodiments, an unlabeled image is associated with one or more metadata vectors and the unlabeled image's coverage score is associated with whether the one or more metadata vectors are labeled. In some embodiments, the corpus management system can select unlabeled images that have coverage scores lower than a threshold.

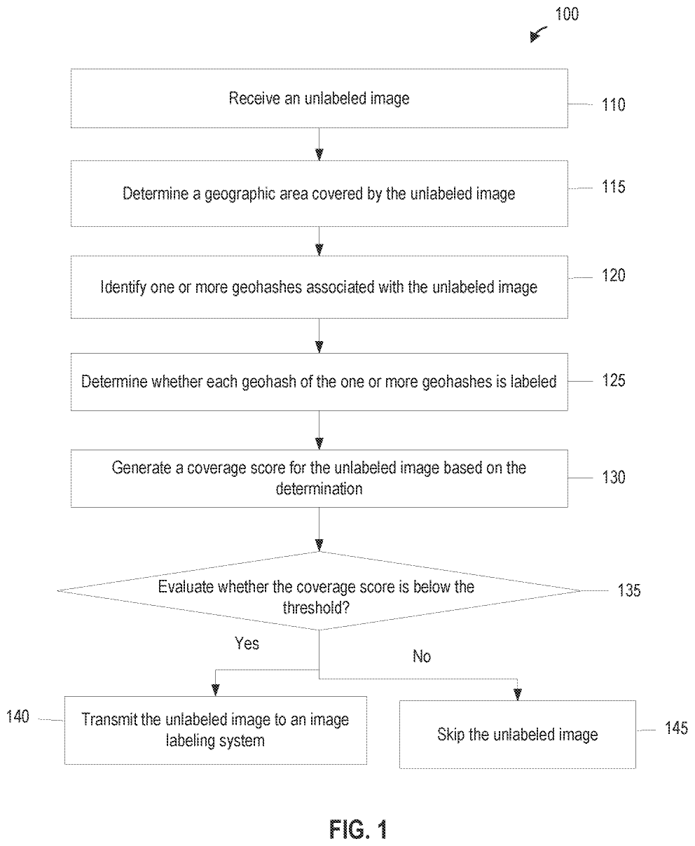

FIG. 1 is a simplified diagram showing a method 100 for corpus management according to certain embodiments of the present disclosure. This diagram is merely an example. One of ordinary skill in the art would recognize many variations, alternatives, and modifications. The method 100 for corpus management includes processes 110, 115, 120, 125, 130, 135, 140, and 145. Although the above has been shown using a selected group of processes for the method 100 for corpus management, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at the process 110, a corpus management component (e.g., a corpus management system, a corpus management engine, a corpus management solution, etc.) is configured to receive an unlabeled image, for example, by retrieving from a data repository and/or received from another component (e.g., another system, another solution). In certain embodiments, at the process 115, the corpus management component is configured to determine a geographic area for the unlabeled image. In some embodiments, the corpus management component is configured to extract metadata from the unlabeled image, where the metadata includes geographic metadata (e.g., geohashes, longitude/latitude of a point in the image, longitude/latitude ranges, etc.). In certain embodiments, the corpus management component is configured to determine a geographic area covered by the unlabeled image, also referred to as a bounding geographic area of the image. In some embodiments, the corpus management component is configured to determine a geographic area covered by the unlabeled image based at least in part on the geographic metadata of the unlabeled image. In certain embodiments, the corpus management component is configured to determine a bounding geographic area covered by the unlabeled image based at least in part on the longitude and latitude data of the unlabeled image.

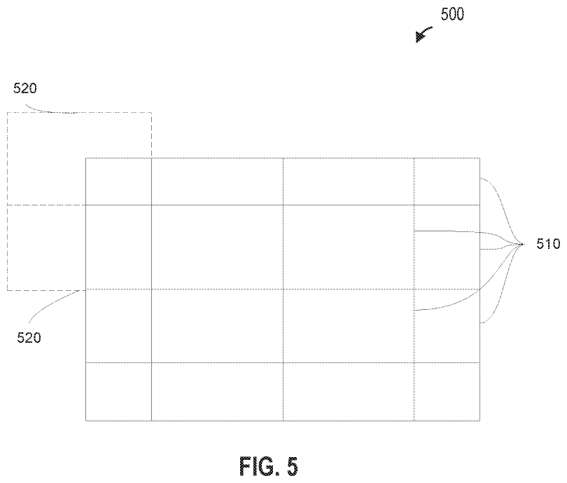

According to certain embodiments, at the process 120, the corpus management component is configured to identify one or more geohashes associated with the unlabeled image. In some embodiments, the corpus management component is configured to identify the one or more geohashes associated with the unlabeled image based at least in part on the bounding geographic area for the unlabeled image. In certain embodiments, the corpus management component is configured to identify the one or more geohashes associated with the unlabeled image based at least in part on geographic metadata extracted from the unlabeled image. In some embodiments, the geographic metadata includes the one or more geohashes. In certain embodiments, a geohash can be of a specific encoding, for example, an eight-character geohash, a four-character geohash, a twelve-character geohash, or the like. In some embodiments, a geohash represents a geographic area. In certain embodiments, the one or more geohashes associated with the unlabeled image includes a geohash corresponding to a geographic area that is partially covered by the unlabeled image. FIG. 5 illustrates an example image 500 covering a plurality of geohash regions 510, which can be represented by a plurality of corresponding geohashes. In this example, the plurality of geohash regions 510 includes a geohash region (e.g., a geographic area) 520 that is partially covered by the image.

According to some embodiments, at the process 125, the corpus management component is configured to determine whether each geohash of the one or more geohashes is labeled. In certain embodiments, the corpus management component is configured to generate a list of labeled geohashes, for example, in corpus repository, where each labeled geohash in the list of labeled geohashes is corresponding to at least one labeled image covering a geographic area corresponding the geohash. In some embodiments, the determining whether each geohash of the one or more geohashes is labeled by determining whether the each geohash of the one or more geohashes is in the list of labeled geohashes.

In certain embodiments, each geohash of the one or more geohashes associated with the unlabeled image is assigned to a labeling score. In some embodiments, the labeling score is a high score (e.g., 1, 100) if the geohash is labeled and a low score (e.g., 0) if the geohash is unlabeled. In certain embodiments, the labeling score is assigned to a score associated with a number of images (e.g., 100 images) being associated with the geohash. In some embodiments, the labeling score is assigned to a score associated with a number of images (e.g., 100 images) being associated with the geohash and a baseline (e.g., 1000 images, a total number of images in the training corpus, etc.). In certain embodiments, the labeling score is a normalized score (e.g., between 0 and 1, between 1 and 100).

According to certain embodiments, at the process 130, the corpus management component is configured to generate a coverage score for the unlabeled image based on the determination of whether the one or more associated geohashes are labeled. In some embodiments, the corpus management component is configured to generate the coverage score for the unlabeled image based on one or more labeling scores corresponding to the one or more geohashes associated with the unlabeled image. In certain embodiments, the coverage score is an average of the labeling scores of the one or more geohashes associated with the unlabeled image. For example, the coverage score is 0.5 for an image covering a first geohash that is labeled and assigned with a first labeling score of 1 and a second geohash that is unlabeled and assigned with a second labeling score of 0.

In some embodiments, the coverage score is a weighted average of the labeling scores of the one or more geohashes associated with the unlabeled image. In certain embodiments, the weights are associated with the coverage by the unlabeled image. For example, a first weight for a first geohash is 1.0 where the unlabeled image covers one-hundred percent (100%) of a first geographic area corresponding to the first geohash and a second weight or a second geohash is 0.4 where the unlabeled image covers forty percent (40%) of a second geographic area corresponding to the second geohash.

According to certain embodiments, at the process 135, the corpus management component is configured to evaluate whether the coverage score is below a threshold (e.g., 0.5). In some embodiments, the threshold is a predetermined threshold. In certain embodiments, the threshold is a dynamic threshold that is changed based on the training corpus. In some embodiments, if the coverage score is below the threshold, at the process 140, the corpus management component is configured to transmit the unlabeled image or an indication of the unlabeled image to an image labeling system. In certain embodiments, the corpus management component is configured to mark the unlabeled image with an indication of labeling, indicative that the unlabeled image should be labeled or has high priority to be labeled. In some embodiments, if the coverage score is not below the threshold, at the process 145, the corpus management component is configured to skip the unlabeled image. In certain embodiments, the corpus management component is configured to mark the unlabeled image with an indication of no-labeling, indicative that the unlabeled image should not be labeled or has low priority to be labeled.

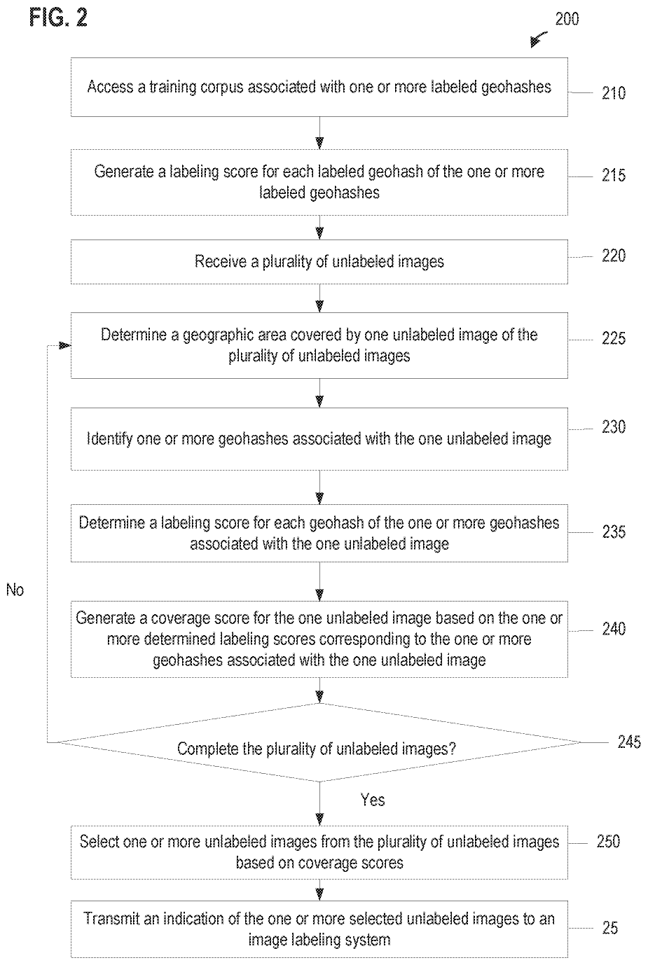

FIG. 2 is a simplified diagram showing a method 200 for corpus management according to certain embodiments of the present disclosure. This diagram is merely an example. One of ordinary skill in the art would recognize many variations, alternatives, and modifications. The method 200 for corpus management includes processes 210, 215, 220, 225, 230, 235, 240, 245, 250, and 255. Although the above has been shown using a selected group of processes for the method 200 for corpus management, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at the process 210, a corpus management component (e.g., a corpus management system, a corpus management engine, a corpus management solution, etc.) is configured to access a training corpus associated with one or more labeled geohashes. In certain embodiments, the corpus management component is configured to generate a list of labeled geohashes in the training corpus, where each labeled geohash in the list of labeled geohashes is corresponding to at least one labeled image covering a geographic area corresponding to the labeled geohash.

According to certain embodiments, at the process 215, the corpus management component is configured to generate a labeling score for each labeled geohash of the one or more labeled geohashes in the training corpus. In some embodiments, the corpus management component is configured to set the labeling score to a high score (e.g., 1, 100, etc.) for each labeled geohash of the one or more labeled geohashes in the training corpus. In certain embodiments, the labeling score is assigned to a score related to a number of images (e.g., 100 images) being associated with the geohash. In some embodiments, the labeling score is assigned to a score associated with a number of images (e.g., 100 images) being associated with the geohash and a baseline (e.g., 1000 images, a total number of images in the training corpus, etc.). In certain embodiments, the labeling score is a normalized score between a low score and a high score (e.g., between 0 and 1, between 1 and 100).

According to some embodiments, at the process 220, the corpus management component is configured to receive a plurality of unlabeled images (e.g., videos, still images, live images, image sequences, etc.), for example, by retrieving from a data repository and/or received from another component (e.g., another system, another solution). In certain embodiments, at the process 225, the corpus management component is configured to determine a geographic area for one unlabeled image of the plurality of unlabeled images. In some embodiments, the corpus management component is configured to extract metadata from the one unlabeled image, where the metadata includes geographic metadata (e.g., geohashes, longitude/latitude of a point in the image, longitude/latitude ranges, etc.). In some embodiments, the corpus management component is configured to determine a geographic area covered by the unlabeled image based at least in part on the geographic metadata of the unlabeled image. In certain embodiments, the corpus management component is configured to determine a bounding geographic area covered by the unlabeled image based at least in part on the longitude and latitude data of the unlabeled image.

According to certain embodiments, at the process 230, the corpus management component is configured to identify one or more geohashes associated with the one unlabeled image. In some embodiments, the corpus management component is configured to identify the one or more geohashes associated with the unlabeled image based at least in part on the bounding geographic area for the one unlabeled image. In certain embodiments, the corpus management component is configured to identify the one or more geohashes associated with the one unlabeled image based at least in part on geographic metadata extracted from the one unlabeled image. In some embodiments, the geographic metadata includes the one or more geohashes. In certain embodiments, a geohash can be of a specific encoding, for example, an eight-character geohash, a four-character geohash, a twelve-character geohash, or the like. In some embodiments, a geohash represents a geographic area. FIG. 5 illustrates an example image 500 covering a plurality of geohash regions 510, which can be represented by a plurality of corresponding geohashes. In this example, the plurality of geohash regions 510 includes one or more geohash regions (e.g., one or more geographic areas) 520 that are partially covered by the image.

According to some embodiments, at the process 235, the corpus management component is configured to determine a labeling score for each geohash of the one or more geohashes associated with the one unlabeled image. In certain embodiments, the labeling score is set to the labeling score of the same labeled geohash in the one or more labeled geohash in the training corpus. In some embodiments, if a geohash is one of the one or more labeled geohashes, the corpus management is configured to use the corresponding labeling score (e.g., 1, 0.4, etc.) for the geohash; and if the geohash is not any one of the one or more labeled geohashes, the corpus management component is configured to set the labeling score to a low score for the geohash.

According to certain embodiments, at the process 240, the corpus management component is configured to generate a coverage score for the one unlabeled image based on the one or more determined labeling scores corresponding to the one or more geohashes associated with the one unlabeled image. In some embodiments, the coverage score is an average of the labeling scores of the one or more geohashes associated with the unlabeled image. For example, the coverage score is 0.5 for an image covering a first geohash that is labeled and assigned with a first labeling score of 1 and a second geohash that is unlabeled and assigned with a second labeling score of 0.

In certain embodiments, the coverage score is a weighted average of the labeling scores of the one or more geohashes associated with the unlabeled image. In certain embodiments, the weights are associated with the coverage by the unlabeled image. For example, a first weight for a first geohash is 1.0 where the unlabeled image covers one-hundred percent (100%) of a first geographic area corresponding to the first geohash and a second weight or a second geohash is 0.4 where the unlabeled image covers forty percent (40%) of a second geographic area corresponding to the second geohash.

According to certain embodiments, at the process 245, the corpus management component is configured to evaluate whether a coverage score has been generated for each unlabeled image of the plurality of unlabeled images. In some embodiments, if each unlabeled image of the plurality of unlabeled images has not yet been assigned a coverage score, the corpus management component returns to the process 225 for the next unlabeled image, thereby assigning a coverage score for the next unlabeled image according, as described above. In certain embodiments, if each unlabeled image of the plurality of unlabeled images has been assigned with coverage scores, the corpus management component is instead configured to go to the process 250, to select one or more unlabeled images from the plurality of unlabeled images based on the coverage scores of the plurality of unlabeled images.

In some embodiments, the corpus management component is configured to select the one or more unlabeled images via applying a filter to coverage scores. In certain embodiments, the corpus management component is configured to select the one or more unlabeled images having coverage scores below a threshold (e.g., 0.5). In some embodiments, the threshold is a predetermined threshold. In certain embodiments, the threshold is a dynamic threshold that is changed based on the training corpus. In some embodiments, the corpus management component is configured to select the one or more unlabeled images via prioritization. For example, the image having a lower coverage score is assigned to a higher priority.

According to certain embodiments, at the process 255, the corpus management component is configured to transmit an indication of the one or more selected unlabeled images to an image labeling system. In some embodiments, the corpus management component is configured to mark each unlabeled image of the one or more selected unlabeled images with an indication of labeling, indicative that the unlabeled image should be labeled or has a high priority to be labeled.

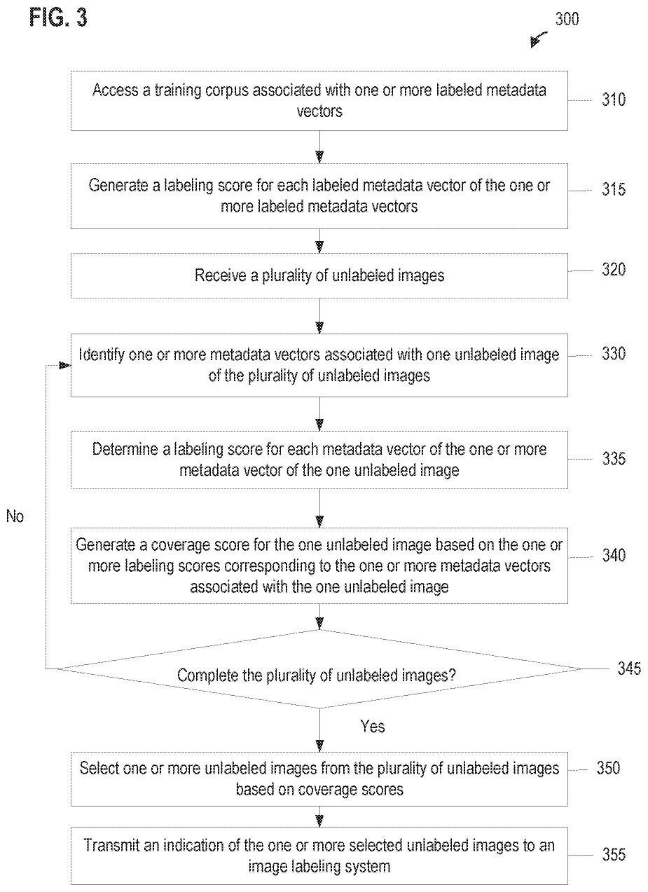

FIG. 3 is a simplified diagram showing a method 300 for corpus management according to certain embodiments of the present disclosure. This diagram is merely an example. One of ordinary skill in the art would recognize many variations, alternatives, and modifications. The method 300 for corpus management includes processes 310, 315, 320, 330, 335, 340, 345, 350, and 355. Although the above has been shown using a selected group of processes for the method 300 for corpus management, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at the process 310, a corpus management component (e.g., a corpus management system, a corpus management engine, a corpus management solution, etc.) is configured to access a training corpus associated with one or more labeled metadata vectors. In certain embodiments, the corpus management system is configured to generate a list of labeled metadata vectors in the training corpus, where each labeled metadata vector in the list of labeled metadata vectors is corresponding to at least one labeled image covering the metadata vector of one or more dimensions (e.g., geographic metadata, time metadata, [geohash, season]). For example, the system identifies labeled images covering a first geohash region in the spring season.

According to certain embodiments, at the process 315, the corpus management component is configured to generate a labeling score for each labeled metadata vector of the one or more labeled metadata vectors in the training corpus. In some embodiments, the corpus management component is configured to set the labeling score to a high score (e.g., 1, 100, etc.) for each labeled metadata vector of the one or more labeled metadata vectors in the training corpus. In certain embodiments, the labeling score is assigned to a score related to a number of images (e.g., 100 images) being associated with the metadata vector. In some embodiments, the labeling score is assigned to a score associated with a number of images (e.g., 100 images) being associated with the metadata vector and a baseline (e.g., 1000 images, a total number of images in the training corpus, etc.). In certain embodiments, the labeling score is a normalized score between a low score and a high score (e.g., between 0 and 1, between 1 and 100).

According to some embodiments, at the process 320, the corpus management component is configured to receive a plurality of unlabeled images (e.g., videos, still images, live images, image sequences, etc.), for example, by retrieving from a data repository and/or received from another component (e.g., another system, another solution). According to certain embodiments, at the process 330, the corpus management component is configured to identify one or more metadata vectors associated with one unlabeled image of the plurality of unlabeled images. In some embodiments, the corpus management component is configured to identify the one or more metadata vectors associated with the unlabeled image based at least in part on the bounding geographic area for the one unlabeled image. In certain embodiments, the corpus management component is configured to identify the one or more metadata vectors associated with the one unlabeled image based at least in part on metadata extracted from the one unlabeled image. In some embodiments, the metadata vector includes a geohash.

According to some embodiments, at the process 335, the corpus management component is configured to determine a labeling score for each metadata vector of the one or more metadata vectors associated with the one unlabeled image. In certain embodiments, the labeling score is set to the labeling score of the same labeled metadata vector in the one or more labeled metadata vectors in the training corpus. In some embodiments, if a geohash is one of the one or more labeled geohashes, the corpus management is configured to use the corresponding labeling score (e.g., 1, 0.4, etc.) for the metadata vector; and if the metadata vector is not any one of the one or more labeled metadata vectors, the corpus management component is configured to set the labeling score to a low score for the metadata vector.

According to certain embodiments, at the process 340, the corpus management component is configured to generate a coverage score for the one unlabeled image based on the one or more determined labeling scores corresponding to the one or more metadata vectors associated with the one unlabeled image. In some embodiments, the coverage score is an average of the labeling scores of the one or more metadata vectors associated with the unlabeled image. For example, the coverage score is 0.5 for an image covering a first metadata vector that is labeled and assigned with a first labeling score of 1 and a second metadata vector that is unlabeled and assigned with a second labeling score of 0.

In certain embodiments, the coverage score is a weighted average of the labeling scores of the one or more metadata vectors associated with the unlabeled image. In some embodiments, the weights are associated with the coverage by the unlabeled image. According to certain embodiments, at the process 345, the corpus management component is configured to evaluate whether a coverage score has been generated for each unlabeled image of the plurality of unlabeled images. In some embodiments, if not each unlabeled image of the plurality of unlabeled images has been assigned with coverage scores, the corpus management component is configured to go back to the process 330 for the next unlabeled image. In certain embodiments, if each unlabeled image of the plurality of unlabeled images has been assigned with coverage scores, the corpus management component is configured to go to the process 350, to select one or more unlabeled images from the plurality of unlabeled images based on the coverage scores of the plurality of unlabeled images.

In some embodiments, the corpus management component is configured to select the one or more unlabeled images via applying a filter to coverage scores. In certain embodiments, the corpus management component is configured to select the one or more unlabeled images having coverage scores below a threshold (e.g., 0.5). In some embodiments, the threshold is a predetermined threshold. In certain embodiments, the threshold is a dynamic threshold that is changed based on the training corpus. In some embodiments, the corpus management component is configured to select the one or more unlabeled images via prioritization. For example, the image having a lower coverage score is assigned to a higher priority.

According to certain embodiments, at the process 355, the corpus management component is configured to transmit an indication of the one or more selected unlabeled images to an image labeling system. In some embodiments, the corpus management component is configured to mark each unlabeled image of the one or more selected unlabeled images with an indication of labeling, indicative that the unlabeled image should be labeled or has a high priority to be labeled.

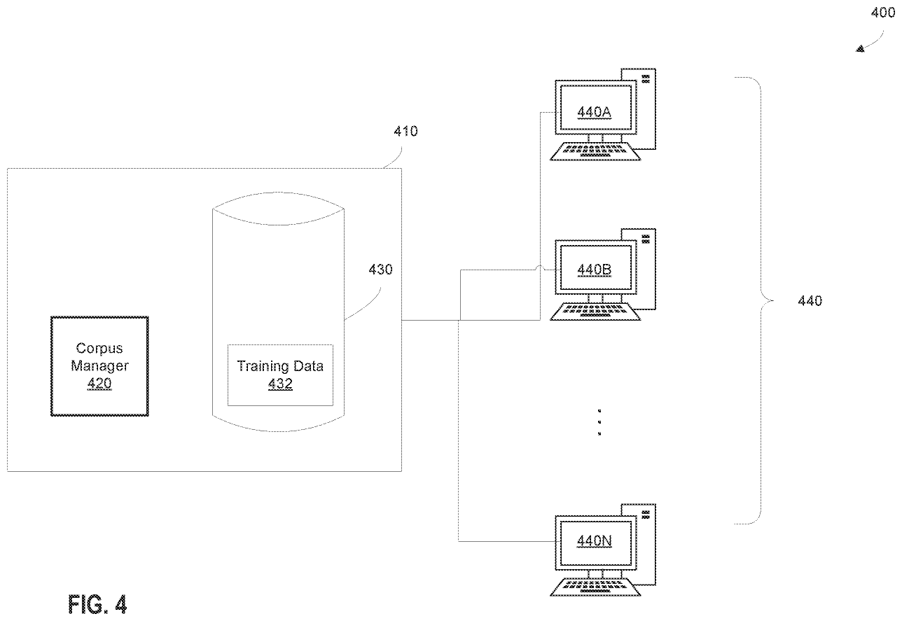

FIG. 4 is an illustrative example of a corpus management environment 400, according to certain embodiments of the present disclosure. FIG. 4 is merely an example. One of the ordinary skilled in the art would recognize many variations, alternatives, and modifications. According to certain embodiments, the corpus management environment 400 includes a corpus management system 410 and one or more image labeling systems 440 (e.g., image labeling system 440A, image labeling system 440B, . . . , image labeling system 440N). According to some embodiments, the corpus management system 410 includes one or more corpus managers 420 (e.g., processors for corpus management) and one or more memories 430, also refers to as data repositories 430. In certain embodiments, the repository 430 includes one or more training data repository 432 for storing data (e.g., labeled images for training one or more AI models, raw data, unlabeled data, etc.). In some embodiments, the repository 430 can be accessed by the one or more image labeling systems 440. Although the above has been shown using a selected group of components in the corpus management environment 400, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to some embodiments, the corpus management system 410 and/or the corpus manager 420 is configured to access a training corpus, for example, the training data repository 432, associated with one or more labeled geohashes. In certain embodiments, the corpus management system 410 and/or the corpus manager 420 is configured to generate a list of labeled geohashes in the training corpus, where each labeled geohash in the list of labeled geohashes is corresponding to at least one labeled image covering a geographic area corresponding to the labeled geohash.

According to certain embodiments, the corpus management system 410 and/or the corpus manager 420 is configured to generate a labeling score for each labeled geohash of the one or more labeled geohashes in the training corpus, for example, the training data repository 432. In some embodiments, the corpus management system 410 and/or the corpus manager 420 is configured to set the labeling score to a high score (e.g., 1, 100, etc.) for each labeled geohash of the one or more labeled geohashes in the training corpus. In certain embodiments, the labeling score is assigned to a score related to a number of images (e.g., 100 images) being associated with the geohash. In some embodiments, the labeling score is assigned to a score associated with a number of images (e.g., 100 images) being associated with the geohash and a baseline (e.g., 1000 images, a total number of images in the training corpus, etc.). In certain embodiments, the labeling score is a normalized score between a low score and a high score (e.g., between 0 and 1, between 1 and 100).

According to some embodiments, the corpus management system 410 and/or the corpus manager 420 is configured to receive a plurality of unlabeled images (e.g., videos, still images, live images, image sequences, etc.), for example, by retrieving from a data repository (e.g., training data repository 432) and/or received from another component (e.g., another system, another solution). In certain embodiments, the corpus management system 410 and/or the corpus manager 420 is configured to determine a geographic area for one unlabeled image of the plurality of unlabeled images. In some embodiments, the corpus management system 410 and/or the corpus manager 420 is configured to extract metadata from the one unlabeled image, where the metadata includes geographic metadata (e.g., geohashes, longitude/latitude of a point in the image, longitude/latitude ranges, etc.).

In certain embodiments, the corpus management system 410 and/or the corpus manager 420 is configured to determine a geographic area covered by the unlabeled image, also referred to as a bounding geographic area of the image. In some embodiments, the corpus management system 410 and/or the corpus manager 420 is configured to determine a geographic area covered by the unlabeled image based at least in part on the geographic metadata of the unlabeled image. In certain embodiments, the corpus management system 410 and/or the corpus manager 420 is configured to determine a bounding geographic area covered by the unlabeled image based at least in part on the longitude and latitude data of the unlabeled image.

According to certain embodiments, the corpus management system 410 and/or the corpus manager 420 is configured to identify one or more geohashes associated with the one unlabeled image. In some embodiments, the corpus management system 410 and/or the corpus manager 420 is configured to identify the one or more geohashes associated with the unlabeled image based at least in part on the bounding geographic area for the one unlabeled image. In certain embodiments, the corpus management system 410 and/or the corpus manager 420 is configured to identify the one or more geohashes associated with the one unlabeled image based at least in part on geographic metadata extracted from the one unlabeled image. In some embodiments, the geographic metadata includes the one or more geohashes. In certain embodiments, a geohash can be of a specific encoding, for example, an eight-character geohash, a four-character geohash, a twelve-character geohash, or the like. In some embodiments, a geohash represents a geographic area. FIG. 5 illustrates an example image 500 covering a plurality of geohash regions 510, which can be represented by a plurality of corresponding geohashes. In this example, the plurality of geohash regions 510 includes one or more geohash regions (e.g., one or more geographic areas) 520 that are partially covered by the image.

According to some embodiments, the corpus management system 410 and/or the corpus manager 420 is configured to determine a labeling score for each geohash of the one or more geohashes associated with the one unlabeled image. In certain embodiments, the labeling score is set to the labeling score of the same labeled geohash in the one or more labeled geohash in the training corpus. In some embodiments, if a geohash is one of the one or more labeled geohashes, the corpus management is configured to use the corresponding labeling score (e.g., 1, 0.4, etc.) for the geohash; and if the geohash is not any one of the one or more labeled geohashes, the corpus management system 410 and/or the corpus manager 420 is configured to set the labeling score to a low score for the geohash.

According to certain embodiments, the corpus management system 410 and/or the corpus manager 420 is configured to generate a coverage score for the one unlabeled image based on the one or more determined labeling scores corresponding to the one or more geohashes associated with the one unlabeled image. In some embodiments, the coverage score is an average of the labeling scores of the one or more geohashes associated with the unlabeled image. For example, the coverage score is 0.5 for an image covering a first geohash that is labeled and assigned with a first labeling score of 1 and a second geohash that is unlabeled and assigned with a second labeling score of 0.

In certain embodiments, the coverage score is a weighted average of the labeling scores of the one or more geohashes associated with the unlabeled image. In certain embodiments, the weights are associated with the coverage by the unlabeled image. For example, a first weight for a first geohash is 1.0 where the unlabeled image covers one-hundred percent (100%) of a first geographic area corresponding to the first geohash and a second weight or a second geohash is 0.4 where the unlabeled image covers forty percent (40%) of a second geographic area corresponding to the second geohash.

According to some embodiments, the corpus management system 410 and/or the corpus manager 420 is configured to access a training corpus associated with one or more labeled metadata vectors. In certain embodiments, the corpus management system is configured to generate a list of labeled metadata vectors in the training corpus, where each labeled metadata vector in the list of labeled metadata vectors is corresponding to at least one labeled image covering the metadata vector of one or more dimensions (e.g., geographic metadata, time metadata, [geohash, season]). For example, the system identifies labeled images covering a first geohash region in the spring season.

According to certain embodiments, the corpus management system 410 and/or the corpus manager 420 is configured to generate a labeling score for each labeled metadata vector of the one or more labeled metadata vectors in the training corpus. In some embodiments, the corpus management system 410 and/or the corpus manager 420 is configured to set the labeling score to a high score (e.g., 1, 100, etc.) for each labeled metadata vector of the one or more labeled metadata vectors in the training corpus. In certain embodiments, the labeling score is assigned to a score related to a number of images (e.g., 100 images) being associated with the metadata vector. In some embodiments, the labeling score is assigned to a score associated with a number of images (e.g., 100 images) being associated with the metadata vector and a baseline (e.g., 1000 images, a total number of images in the training corpus, etc.). In certain embodiments, the labeling score is a normalized score between a low score and a high score (e.g., between 0 and 1, between 1 and 100).

According to some embodiments, the corpus management system 410 and/or the corpus manager 420 is configured to receive a plurality of unlabeled images (e.g., videos, still images, live images, image sequences, etc.), for example, by retrieving from a data repository and/or received from another component (e.g., another system, another solution). According to certain embodiments, the corpus management system 410 and/or the corpus manager 420 is configured to identify one or more metadata vectors associated with one unlabeled image of the plurality of unlabeled images. In some embodiments, the corpus management system 410 and/or the corpus manager 420 is configured to identify the one or more metadata vectors associated with the unlabeled image based at least in part on the bounding geographic area for the one unlabeled image. In certain embodiments, the corpus management system 410 and/or the corpus manager 420 is configured to identify the one or more metadata vectors associated with the one unlabeled image based at least in part on metadata extracted from the one unlabeled image. In some embodiments, the metadata vector includes a geohash.

According to some embodiments, the corpus management system 410 and/or the corpus manager 420 is configured to determine a labeling score for each metadata vector of the one or more metadata vectors associated with the one unlabeled image. In certain embodiments, the labeling score is set to the labeling score of the same labeled metadata vector in the one or more labeled metadata vectors in the training corpus. In some embodiments, if a geohash is one of the one or more labeled geohashes, the corpus management is configured to use the corresponding labeling score (e.g., 1, 0.4, etc.) for the metadata vector; and if the metadata vector is not any one of the one or more labeled metadata vectors, the corpus management system 410 and/or the corpus manager 420 is configured to set the labeling score to a low score for the metadata vector.

According to certain embodiments, the corpus management system 410 and/or the corpus manager 420 is configured to generate a coverage score for the one unlabeled image based on the one or more determined labeling scores corresponding to the one or more metadata vectors associated with the one unlabeled image. In some embodiments, the coverage score is an average of the labeling scores of the one or more metadata vectors associated with the unlabeled image. For example, the coverage score is 0.5 for an image covering a first metadata vector that is labeled and assigned with a first labeling score of 1 and a second metadata vector that is unlabeled and assigned with a second labeling score of 0.

According to certain embodiments, the corpus management system 410 and/or the corpus manager 420 is configured to evaluate whether a coverage score has been generated for each unlabeled image of the plurality of unlabeled images. In some embodiments, if not each unlabeled image of the plurality of unlabeled images has been assigned with coverage scores, the corpus management system 410 and/or the corpus manager 420 is configured to go back to the process for the next unlabeled image. In certain embodiments, if each unlabeled image of the plurality of unlabeled images has been assigned with coverage scores, the corpus management system 410 and/or the corpus manager 420 is configured to select one or more unlabeled images from the plurality of unlabeled images based on the coverage scores of the plurality of unlabeled images.

In some embodiments, the corpus management system 410 and/or the corpus manager 420 is configured to select the one or more unlabeled images via applying a filter to coverage scores. In certain embodiments, the corpus management system 410 and/or the corpus manager 420 is configured to select the one or more unlabeled images having coverage scores below a threshold (e.g., 0.5). In some embodiments, the threshold is a predetermined threshold. In certain embodiments, the threshold is a dynamic threshold that is changed based on the training corpus. In some embodiments, the corpus management system 410 and/or the corpus manager 420 is configured to select the one or more unlabeled images via prioritization. For example, the image having a lower coverage score is assigned to a higher priority.

According to certain embodiments, the corpus management system 410 and/or the corpus manager 420 is configured to transmit an indication of the one or more selected unlabeled images to an image labeling system. In some embodiments, the corpus management system 410 and/or the corpus manager 420 is configured to mark each unlabeled image of the one or more selected unlabeled images with an indication of labeling, indicative that the unlabeled image should be labeled or has a high priority to be labeled.

In some embodiments, the repository 430 can include images, unlabeled images, training data, labeled images, labeled training data, geohashes, labeled geohashes, metadata vectors associated with images, labelled metadata vectors, labeling scores, coverage scores, and/or the like. The repository 430 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the corpus management environment 400 can execute software or firmware stored in non-transitory computer-readable medium to implement various processing steps. Various components and processors of the corpus management environment 400 can be implemented by one or more computing devices including, but not limited to, circuits, a computer, a cloud-based processing unit, a processor, a processing unit, a microprocessor, a mobile computing device, and/or a tablet computer. In some cases, various components of the corpus management environment 400 (e.g., the corpus manager 420, the corpus management system 410, the image labeling systems 440) can be implemented on a shared computing device. Alternatively, a component of the corpus management environment 400 can be implemented on multiple computing devices. In some implementations, various modules and components of the corpus management environment 400 can be implemented as software, hardware, firmware, or a combination thereof. In some cases, various components of the corpus management environment 400 can be implemented in software or firmware executed by a computing device.

Various components of the corpus management environment 400 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

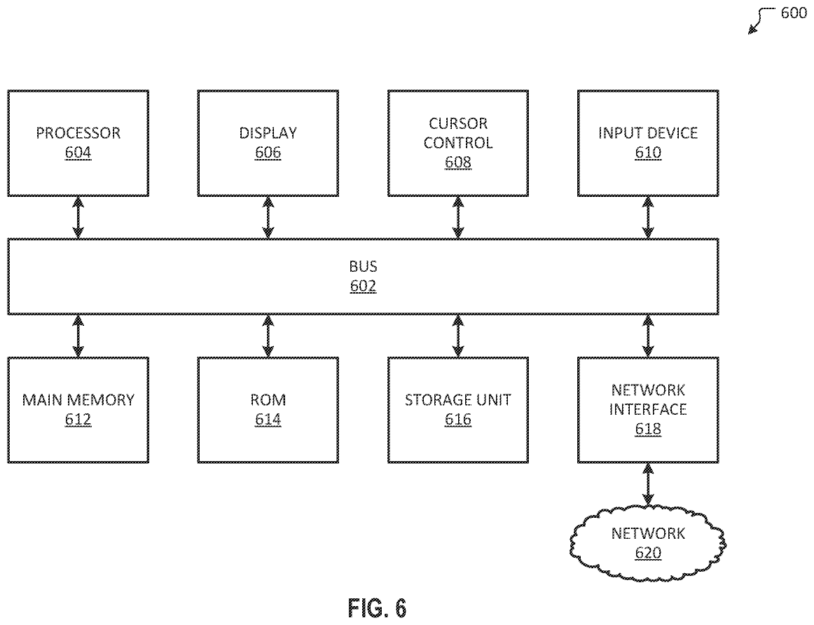

FIG. 6 is a simplified diagram showing a computing system for implementing a system 600 for corpus management in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 100, 200 and/or 300 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for managing data corpus, the method comprising: receiving an unlabeled image; identifying one or more geohashes associated with the unlabeled image; determining whether each geohash of the one or more geohashes is labeled; generating a coverage score for the unlabeled image based on the determination; evaluating whether the coverage score is below a predetermined threshold; in response to the coverage score being below the predetermined threshold, transmitting the unlabeled image to an image labeling system; wherein the method is performed using one or more processors. For example, the method is implemented according to at least FIG. 1, FIG. 3, and/or FIG. 4.

In some embodiments, the identifying one or more geohashes associated with the unlabeled image comprises: determining a bounding geographic area for the unlabeled image; and identifying the one or more geohashes associated with the unlabeled image based at least in part on the bounding geographic area. In certain embodiments, the identifying one or more geohashes associated with the unlabeled image comprises: extracting image metadata from the unlabeled image; and identifying the one or more geohashes associated with the unlabeled image based at least in part on the image metadata. In some embodiments, the method further comprises: in response to the coverage score being above the predetermined threshold, skipping the unlabeled image for labeling. In some embodiments, the one or more geohashes include a geohash corresponding to a geographic area that is partially covered by the unlabeled image. In some embodiments, the method further comprises: generating a list of labeled geohashes, each labeled geohash in the list of labeled geohashes being corresponding to at least one labeled image covering a geographic area corresponding the each labeled geohash; wherein the determining whether each geohash of the one or more geohashes is labeled comprises determining whether each geohash of the one or more geohashes is in the list of labeled geohashes.

In certain embodiments, each labeled geohash in the list of labeled geohashes is corresponding to a labeling score; wherein the generating a coverage score for the unlabeled image based on the determination comprises generating the coverage score for the unlabeled image based on one or more labeling scores corresponding to the one or more geohashes associated with the unlabeled image. In some embodiments, the generating a coverage score for the unlabeled image based on the determination comprises: assigning each geohash of the one or more geohashes associated with the unlabeled image to a labeling score, the labeling score being a high score if a corresponding geohash is labeled, the labeling core being a low score if a corresponding geohash is unlabeled; and generating the coverage score for the unlabeled image as a weighted average of one or more labeling scores assigned to the one or more geohashes.

According to some embodiments, a method for managing data corpus, the method comprising: receiving a plurality of unlabeled images; for each unlabeled image of the plurality of unlabeled images: identifying one or more geohashes associated with the each unlabeled image of the plurality of unlabeled images; determining whether each geohash of the one or more geohashes is labeled; generating a coverage score for the each unlabeled image of the plurality of unlabeled images based on the determination; selecting one or more unlabeled images from the plurality of unlabeled images based on one or more coverage scores associated with the one or more unlabeled images; and transmitting an indication of the one or more selected unlabeled images to an image labeling system; wherein the method is performed using one or more processors. For example, the method is implemented according to at least FIG. 2, FIG. 3, and/or FIG. 4.

In some embodiments, the identifying one or more geohashes associated with the unlabeled image comprises: determining a bounding geographic area for the unlabeled image; and identifying the one or more geohashes associated with the unlabeled image based at least in part on the bounding geographic area. In certain embodiments, the identifying one or more geohashes associated with the unlabeled image comprises: extracting image metadata from the unlabeled image; and identifying the one or more geohashes associated with the unlabeled image based at least in part on the image metadata. In some embodiments, the one or more geohashes include a geohash corresponding to a geographic area that is partially covered by the unlabeled image. In some embodiments, the method further comprises: generating a list of labeled geohashes, each labeled geohash in the list of labeled geohashes being corresponding to at least one labeled image covering a geographic area corresponding the each labeled geohash; wherein the determining whether each geohash of the one or more geohashes is labeled comprises determining whether each geohash of the one or more geohashes is in the list of labeled geohashes.

In certain embodiments, each labeled geohash in the list of labeled geohashes is corresponding to a labeling score; wherein the generating a coverage score for the unlabeled image based on the determination comprises generating the coverage score for the unlabeled image based on one or more labeling scores corresponding to the one or more geohashes associated with the unlabeled image. In some embodiments, the generating a coverage score for the unlabeled image based on the determination comprises: assigning each geohash of the one or more geohashes associated with the unlabeled image to a labeling score, the labeling score being a high score if a corresponding geohash is labeled, the labeling core being a low score if a corresponding geohash is unlabeled; and generating the coverage score for the unlabeled image as a weighted average of one or more labeling scores assigned to the one or more geohashes.

In some embodiments, a system for managing data corpus is provided. The system comprises: one or more memories comprising instructions stored thereon; and one or more processors configured to execute the instructions and perform operations comprising: receiving an unlabeled image; identifying one or more geohashes associated with the unlabeled image; determining whether each geohash of the one or more geohashes has been labeled previously; generating a coverage score for the unlabeled image based on the determination; evaluating whether the coverage score is below a predetermined threshold; and in response to the coverage score being below the predetermined threshold, transmitting the unlabeled image to an image labeling system. For example, the system is implemented according to at least the aspects described in reference to FIG. 1, FIG. 3, and/or FIG. 4.

In certain embodiments, the identifying one or more geohashes associated with the unlabeled image comprises: determining a bounding geographic area for the unlabeled image; and identifying the one or more geohashes associated with the unlabeled image based at least in part on the bounding geographic area. In some embodiments, the identifying one or more geohashes associated with the unlabeled image comprises: extracting image metadata from the unlabeled image; and identifying the one or more geohashes associated with the unlabeled image based at least in part on the image metadata. In certain embodiments, the operations further comprise generating a list of labeled geohashes, each labeled geohash in the list of labeled geohashes being corresponding to at least one labeled image covering a geographic area corresponding the each labeled geohash; and the determining whether each geohash of the one or more geohashes is labeled comprises determining whether each geohash of the one or more geohashes is in the list of labeled geohashes. In some embodiments, each labeled geohash in the list of labeled geohashes is corresponding to a labeling score; and the generating a coverage score for the unlabeled image based on the determination comprises generating the coverage score for the unlabeled image based on one or more labeling scores corresponding to the one or more geohashes associated with the unlabeled image.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for managing data corpus, the method comprising:
receiving an unlabeled image;
identifying one or more geohashes associated with the unlabeled image;
determining whether each geohash of the one or more geohashes has been labeled previously;
generating a coverage score for the unlabeled image based on the determination;
evaluating whether the coverage score is below a predetermined threshold;
in response to the coverage score being below the predetermined threshold, transmitting the unlabeled image to an image labeling system;
wherein the method is performed using one or more processors.

2. The method of claim 1, wherein the identifying one or more geohashes associated with the unlabeled image comprises:
determining a bounding geographic area for the unlabeled image; and
identifying the one or more geohashes associated with the unlabeled image based at least in part on the bounding geographic area.

3. The method of claim 1, wherein the identifying one or more geohashes associated with the unlabeled image comprises:
extracting image metadata from the unlabeled image; and
identifying the one or more geohashes associated with the unlabeled image based at least in part on the image metadata.

4. The method of claim 1, further comprising:
in response to the coverage score being above the predetermined threshold, skipping the unlabeled image for labeling.

5. The method of claim 1, wherein the one or more geohashes include a geohash corresponding to a geographic area that is partially covered by the unlabeled image.

6. The method of claim 1, further comprising:
generating a list of labeled geohashes, each labeled geohash in the list of labeled geohashes being corresponding to at least one labeled image covering a geographic area corresponding the each labeled geohash;
wherein the determining whether each geohash of the one or more geohashes is labeled comprises determining whether each geohash of the one or more geohashes is in the list of labeled geohashes.

7. The method of claim 6, wherein each labeled geohash in the list of labeled geohashes is corresponding to a labeling score;
wherein the generating a coverage score for the unlabeled image based on the determination comprises generating the coverage score for the unlabeled image based on one or more labeling scores corresponding to the one or more geohashes associated with the unlabeled image.

8. The method of claim 1, wherein the generating a coverage score for the unlabeled image based on the determination comprises:
assigning each geohash of the one or more geohashes associated with the unlabeled image to a labeling score, the labeling score being a high score if a corresponding geohash is labeled, the labeling core being a low score if a corresponding geohash is unlabeled; and
generating the coverage score for the unlabeled image as a weighted average of one or more labeling scores assigned to the one or more geohashes.

9. A method for managing data corpus, the method comprising:
receiving a plurality of unlabeled images;
for each unlabeled image of the plurality of unlabeled images:
identifying one or more geohashes associated with the each unlabeled image of the plurality of unlabeled images;
determining whether each geohash of the one or more geohashes is labeled;
generating a coverage score for the each unlabeled image of the plurality of unlabeled images based on the determination;
selecting one or more unlabeled images from the plurality of unlabeled images based on one or more coverage scores associated with the one or more unlabeled images; and
transmitting an indication of the one or more selected unlabeled images to an image labeling system;
wherein the method is performed using one or more processors.

10. The method of claim 9, wherein the identifying one or more geohashes associated with the each unlabeled image comprises:
determining a bounding geographic area for the each unlabeled image; and
identifying the one or more geohashes associated with the each unlabeled image based at least in part on the bounding geographic area.

11. The method of claim 9, wherein the identifying one or more geohashes associated with the each unlabeled image comprises:
extracting image metadata from the each unlabeled image; and
identifying the one or more geohashes associated with the each unlabeled image based at least in part on the image metadata.

12. The method of claim 9, wherein the one or more geohashes include a geohash corresponding to a geographic area that is partially covered by the unlabeled image.

13. The method of claim 9, further comprising:
generating a list of labeled geohashes, each labeled geohash in the list of labeled geohashes being corresponding to at least one labeled image covering a geographic area corresponding to the each labeled geohash;
wherein the determining whether each geohash of the one or more geohashes is labeled comprises determining whether each geohash of the one or more geohashes is in the list of labeled geohashes.

14. The method of claim 13, wherein each labeled geohash in the list of labeled geohashes is corresponding to a labeling score;
wherein the generating a coverage score for the unlabeled image based on the determination comprises generating the coverage score for the unlabeled image based on one or more labeling scores corresponding to the one or more geohashes associated with the unlabeled image.

15. The method of claim 9, wherein the generating a coverage score for the each unlabeled image based on the determination comprises:
assigning each geohash of the one or more geohashes associated with the each unlabeled image to a labeling score, the labeling score being a high score if a corresponding geohash is labeled, the labeling core being a low score if a corresponding geohash is unlabeled; and
generating the coverage score for the each unlabeled image as a weighted average of one or more labeling scores assigned to the one or more geohashes.

16. A system for managing data corpus, the system comprising:
one or more memories comprising instructions stored thereon; and
one or more processors configured to execute the instructions and perform operations comprising:
receiving an unlabeled image;
identifying one or more geohashes associated with the unlabeled image;
determining whether each geohash of the one or more geohashes has been labeled previously;
generating a coverage score for the unlabeled image based on the determination;
evaluating whether the coverage score is below a predetermined threshold; and
in response to the coverage score being below the predetermined threshold, transmitting the unlabeled image to an image labeling system.

17. The system of claim 16, wherein the identifying one or more geohashes associated with the unlabeled image comprises:
determining a bounding geographic area for the unlabeled image; and
identifying the one or more geohashes associated with the unlabeled image based at least in part on the bounding geographic area.

18. The system of claim 16, wherein the identifying one or more geohashes associated with the unlabeled image comprises:
extracting image metadata from the unlabeled image; and
identifying the one or more geohashes associated with the unlabeled image based at least in part on the image metadata.

19. The system of claim 16, wherein:
the operations further comprise generating a list of labeled geohashes, each labeled geohash in the list of labeled geohashes being corresponding to at least one labeled image covering a geographic area corresponding the each labeled geohash; and
the determining whether each geohash of the one or more geohashes is labeled comprises determining whether each geohash of the one or more geohashes is in the list of labeled geohashes.

20. The system of claim 19, wherein:
each labeled geohash in the list of labeled geohashes is corresponding to a labeling score; and
the generating a coverage score for the unlabeled image based on the determination comprises generating the coverage score for the unlabeled image based on one or more labeling scores corresponding to the one or more geohashes associated with the unlabeled image.
